(19) United States
(12) Patent Application Publication
(10) Pub. No.: US 2014/0195961 A1
(43) Pub. Date: Jul. 10, 2014

(54) Dynamic Index

(71) Applicant: APPLE INC., Cupertino, CA (US)

(72) Inventors: David J. Shoemaker, Redwood City, CA (US); Michael J. Ingrassia, JR., San Jose, CA (US)

(73) Assignee: APPLE INC., Cupertino, CA (US)

(21) Appl. No.: 13/735,935

(22) Filed: Jan. 7, 2013

(51) Int. Cl. G06F 3/0483; G06F 3/048

(52) U.S. Cl. CPC G06F 3/0483
USPC 715/776

(57) ABSTRACT

In some implementations, a user can select a term (e.g., word or phrase) from the text of a digital media item (e.g., book, document, etc.) and cause an index to other references to the selected term within the digital media item to be generated and presented. The user can provide input to an item within the index to view an expanded preview of the text at the location within the digital media item corresponding to the index item without navigating to the location within the digital media item. The user can provide input to the index item to navigate to the location within the digital media item corresponding to the index item. When viewing a location within the digital media item corresponding to an index item, the user can provide input to navigate to other instances of the same term within the digital media item.

### TECHNICAL FIELD

The disclosure generally relates to generating and navigating indexes.

### BACKGROUND

Indexes for digital media, e.g., text documents, digital books, are generated by a producer of the digital media to allow a user of the digital media to find references to topics, terms, phrases, etc. within the digital media. The index often provides chapter and/or page identifiers to allow the user to navigate to the chapter and/or page that corresponds to an item selected from the index. The user is required to navigate to and from the index to view other entries in the index.

### SUMMARY

In some implementations, a user can select a term (e.g., word or phrase) from the text of a digital media item (e.g., book, document, etc.) and cause an index to other references to the selected term within the digital media item to be generated and presented. The user can provide input to an item within the index to view an expanded preview of the text at the location within the digital media item corresponding to the index item without navigating to the location within the digital media item. The user can provide input to the index item to navigate to the location within the digital media item corresponding to the index item. When viewing a location within the digital media item corresponding to an index item, the user can provide input to navigate to other instances of the same term within the digital media item.

Particular implementations provide at least the following advantages: An index can be dynamically generated for a selected term. The user can quickly navigate between locations of indexed instances of the selected term within a digital media item without having to return to the index.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example graphical user interface for invoking a dynamic index for a digital media item having textual content.

FIG. 2 illustrates an example graphical user interface for invoking a dynamic index for a digital media item having textual content.

FIG. 3 illustrates an example graphical user interface for presenting and interacting with a dynamic index.

FIG. 4 illustrates adjusting the size of an index entry displayed on graphical interface to preview additional content.

FIG. 5 illustrates an example graphical user interface presenting a full screen display of a location within a media item corresponding to an index entry.

FIG. 6 illustrates example mechanisms for returning to the dynamic index from the full screen display GUI.

FIG. 7 is flow diagram of an example process for generating and navigating the dynamic index.

FIG. 8 is a block diagram of an exemplary system architecture implementing the features and processes of FIGS. 1-7.

Like reference symbols in the various drawings indicate like elements.

### DETAILED DESCRIPTION

This disclosure describes various graphical user interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching, de-pinching (e.g., opposite motion of pinch) and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radial buttons, checkboxes and any other mechanism for receiving input from, or providing feedback to a user.

### Invoking the Dynamic Index

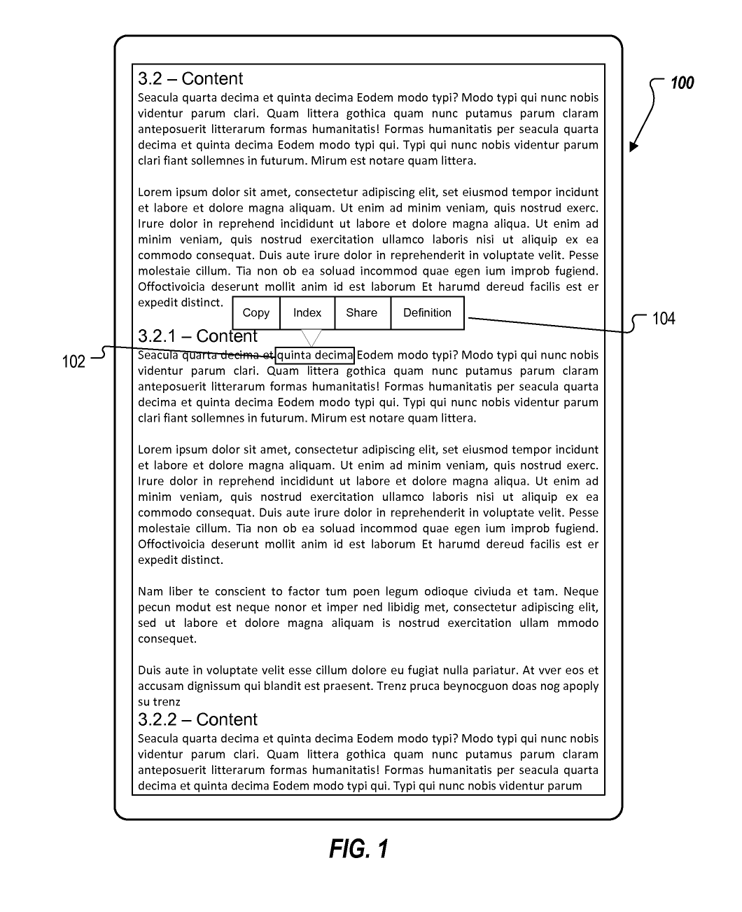

FIG. 1 illustrates an example graphical user interface 100 for invoking a dynamic index for a digital media item having textual content. GUI 100 can be an interface of an application for presenting or interacting with the media item. For example, the digital media item can be a digital book, word processor document, web page, PDF document, collection of digital objects or files, or any other type of media having associated text (e.g., metadata) or other content that can be dynamically indexed. In some implementations, a user can select (e.g., highlight) text 102 displayed on GUI 100. For example, a user can provide touch input (e.g., touching a finger, dragging one or more fingers, etc.) to select a word or phrase displayed on GUI 100. The word or phrase can correspond to a term used throughout the media item, for example.

In some implementations, graphical object 104 can be displayed in response to the selection of text displayed on GUI 100. For example, graphical object 104 can be a menu that presents selectable objects (e.g., buttons) corresponding to functions or operations associated with the media item and/or the application. In some implementations, a user can select a button on graphical object 104 corresponding to an index function to create a dynamic index that presents locations throughout the media item where selected text 102 can be found.

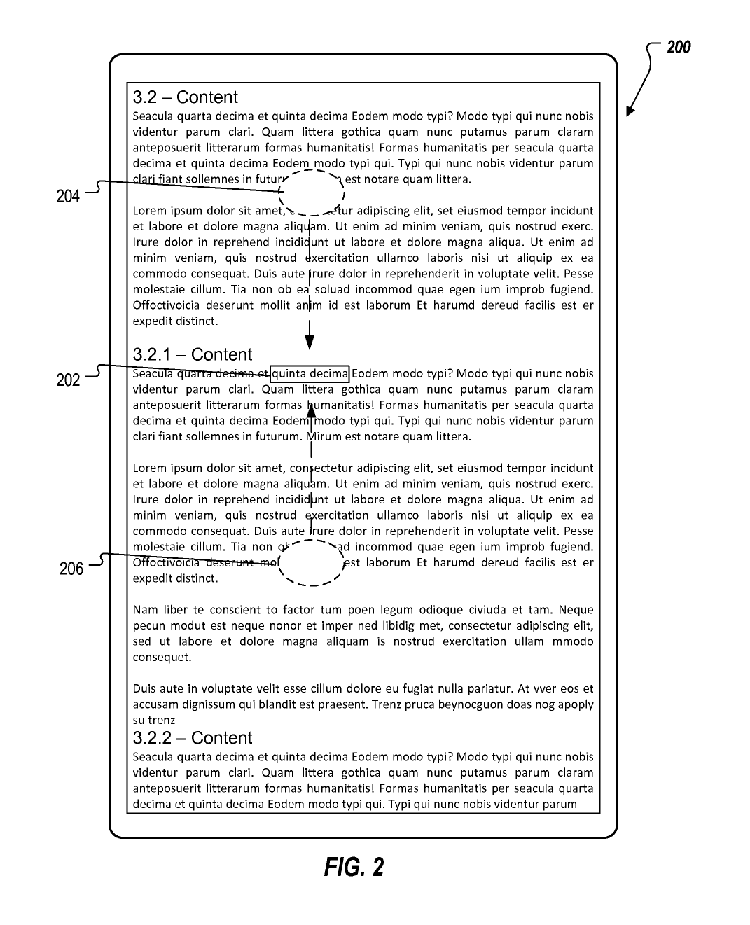

FIG. 2 illustrates an example graphical user interface 200 for invoking a dynamic index for a digital media item having textual content. GUI 200 can be an interface of an application for presenting or interacting with the media item. For example, the digital media item can be a digital book, word processor document, web page, PDF document or any other type of digital file containing text. In some implementations, a user can select (e.g., highlight) text 202 displayed on GUI 200. For example, a user can provide touch input (e.g., touching a finger, dragging one or more fingers, etc.) to select a word or phrase displayed on GUI 200. The word or phrase can correspond to a term used throughout the media item, for example.

In some implementations, a user can input a touch gesture to invoke the dynamic index. For example, the user can touch finger 204 and touch finger 206 to GUI 200 and pinch toward selected text 202 to create a dynamic index that presents locations throughout the media item where instances of selected text 202 can be found.

### The Dynamic Index

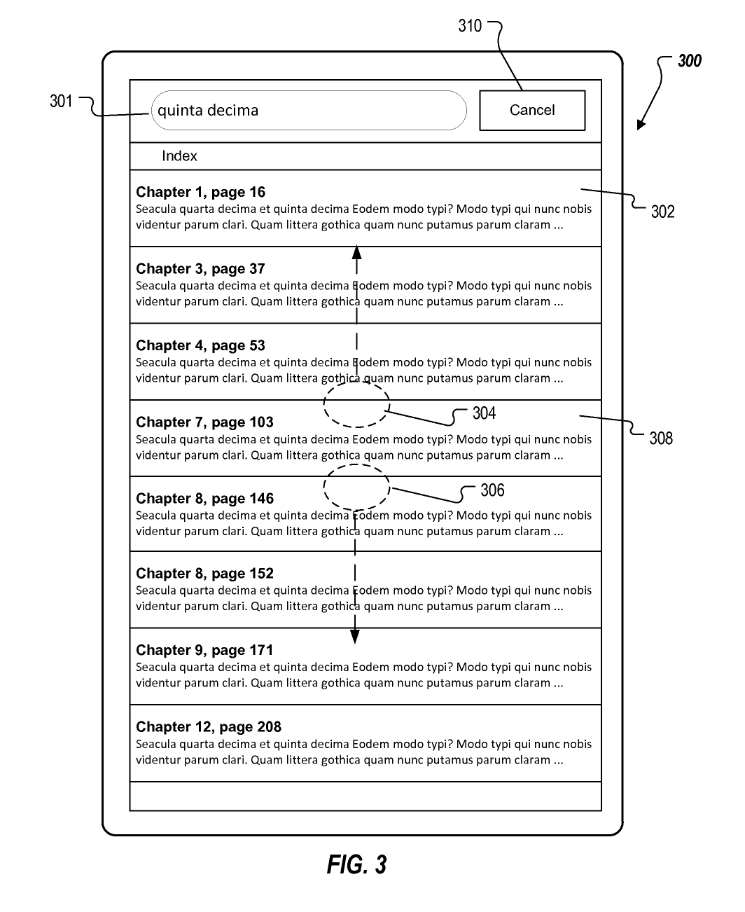

FIG. 3 illustrates an example graphical user interface 300 for presenting and interacting with a dynamic index. For example, in response to an invocation of the dynamic index, as described above with reference to FIGS. 1 and 2, the media item can be searched for locations (e.g., chapters, pages, paragraphs, lines, etc.) where other occurrences or instances of the selected text exists. Where a single word was selected, locations of other instances of the word can be found. Where a phrase was selected, locations of other instances of the entire phrase can be found. In some implementations, just important words from the selected phrase can be found. For example, words such as ‘the,’ ‘a,’ and/or ‘in’ can be ignored and a search performed on other words (e.g., the important, relevant or meaningful words) in the phrase. In some implementations, the dynamic index can be configured to find all words or any words in the selected phrase. For example, the user can specify Boolean search parameters (e.g., and, or, not, near, etc.) to be used when generating the dynamic index based on a multiword phrase. For example, an options user interface can be provided to allow the user to configure search parameters for the dynamic index. In some implementations, GUI 300 can provide a search term input box 301 for generating an index based on user provided text. For example, the user can provide text input (and Boolean parameters, if desired) to input box 301 to generate a dynamic index based on user input.

In some implementations, each entry in the dynamic index displayed on GUI 300 can include an identifier specifying the location in the media item where an instance of the selected text was found and a portion (i.e., preview) of content near the instance of the selected text. For example, if the media item is a digital book, index entry 302 can identify a chapter number and a page number where the instance of the selected text was found. Index entry 302 can present a number of lines of text from near the instance of the selected text to provide context for the index entry. For example, index entry 302 can include the line of text that includes the selected text and the line of text before and/or after the selected text.

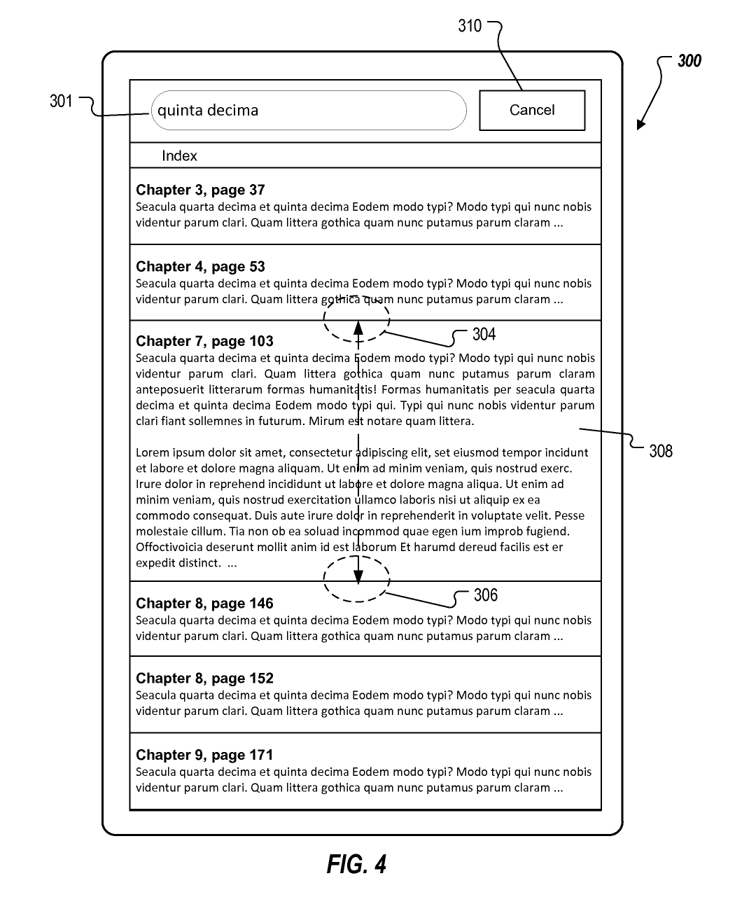

In some implementations, the user can provide input to GUI 300 to preview additional text around an instance of the selected text. For example, the user can provide touch input (e.g., finger touch 304 and finger touch 306) and a de-pinch gesture (e.g., move fingers 304 and 306 apart) with respect to index entry 308 to view more of the text surrounding the location where the corresponding instance of the selected text was found in the media item, as further illustrated by FIG. 4.

FIG. 4 illustrates adjusting the size of an index entry displayed on graphical interface 300 to preview additional content. In some implementations, the amount of preview text shown in an index entry can correspond to the amount of movement detected in the touch input. For example, the size of index entry 308 can be adjusted according to the touch input received. The distance that the user's fingers 304 and 306 move apart while performing the de-pinch gesture can determine how much of GUI 300 will be used to display index entry 308, for example. The bigger index entry 308 gets, the more lines of text will be displayed or previewed in index entry 308. In some implementations, the index entry will revert back to its original size when the user stops providing touch input to GUI 300. For example, index entry 308 can have an original size that allows for four lines of text. When the user performs a de-pinch gesture as input to GUI 300 the size of index entry 308 can be expanded to ten, fifteen or twenty lines, for example according to how far apart the user moves the user's fingers. In some implementations, index entry 308 can maintain its expanded size as long as the user continues to provide touch input to GUI 300. In some implementations, once the user ceases providing the touch input (e.g., lifts his or her fingers from the touch interface) to GUI 300, index entry 308 can revert or snap back to its original four line size.

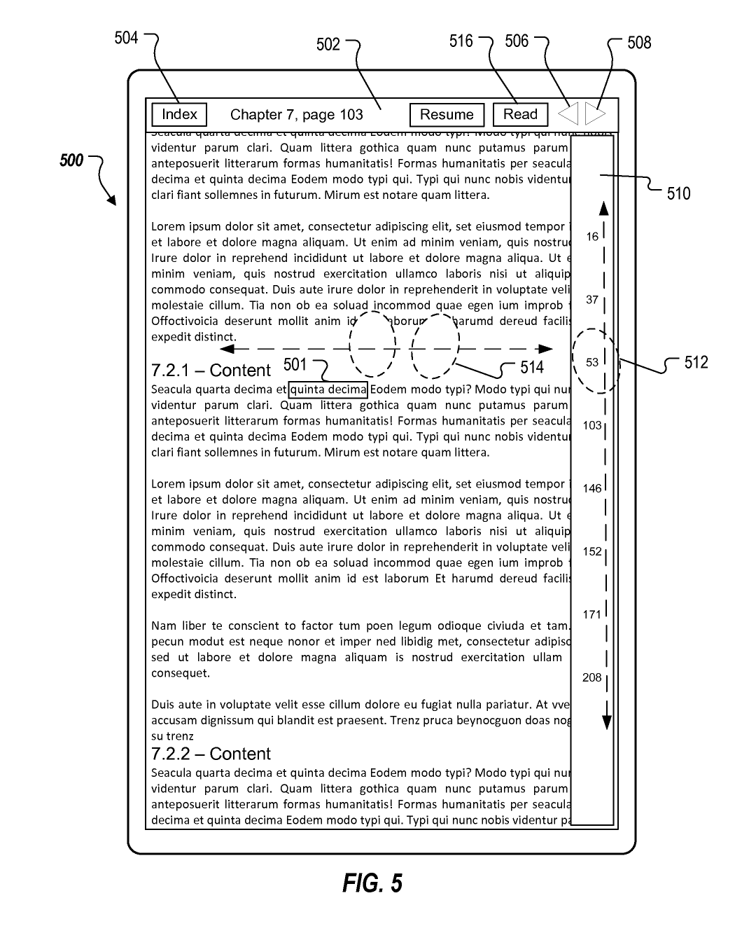

In some implementations, if the size of the index entry becomes greater than a threshold size, a full screen display of the index entry will be presented. For example, when the media item is a digital book, if the size of an index entry becomes greater than 90% of the size of GUI 300, then the index of GUI 300 will be hidden and a full screen (or full window) display of the page of the book corresponding to the index entry will be displayed, as illustrated by FIG. 5. In some implementations, a full screen display can display a full screen or nearly full screen display of content at a location in the media item (e.g., book, document, file, collection of files or objects) corresponding to the index entry. For example, if GUI 300 is a window of a windowed operating system that displays applications in windows over a desktop, when the size of the index entry becomes greater than a threshold size (e.g., greater than 90% of the GUI 300 window), a full window display of content at the location in the media item corresponding to the index entry can be presented.

In some implementations, instead of displaying a full screen (or full window) of content at a location in the media item, an entire unit or block of content from the media item can be displayed. For example, when the media item is a digital book a unit of content can correspond to a page of the book. Thus, when the index entry becomes greater than a threshold size, an entire page of the book corresponding to the index entry can be displayed. Similarly, if the media item is collection of files or objects, when the index entry becomes greater than a threshold size, an entire file or object corresponding to the index entry can be displayed.

In some implementations, a full screen display (or full window display, or unit of content display) of an index entry can be invoked based on the velocity of the touch input. For example, if the user's fingers slowly move apart (e.g., less than a threshold speed) while performing the de-pinch gesture, then the size of the index entry will correspond to the distance between the user's fingers. However, if the user's finger move apart quickly (e.g., greater than the threshold speed), then a full screen display of the location within the media item (e.g., the page of a digital book) corresponding to the index entry can be displayed, as illustrated by FIG. 5. In some implementations, the user can exit the dynamic index of GUI 300 by selecting graphical object 310. For example, selection of graphical object 310 can return the user to the location in the media item where the dynamic index was invoked.

FIG. 5 illustrates an example graphical user interface 500 presenting a full screen (or full window, or unit of content) display of a location within a media item corresponding to an index entry. For example, a user can provide touch input (e.g., a tap or a de-pinch) corresponding to an index entry to cause a full screen display of a location within a media item to be presented. For example, if the media item is a digital book, the user can tap on or de-pinch an index entry identifying a page in the digital book to cause a full screen display of the page to be presented in GUI 500, as described above. In some implementations, when content associated with an index entry is displayed in GUI 500, the index term 501 (e.g., the term for which the dynamic index was generated) can be highlighted in the displayed content.

In some implementations, GUI 500 can include status bar 502. For example, status bar 502 can include information identifying the location (e.g., “Chapter 7, page 103”) of the currently selected index entry.

### Fast Navigation Between Index Entries

In some implementations, status bar 502 can include graphical objects 506 and/or 508 for navigating between index entries. For example, instead of requiring the user to return to the index of GUI 300 to view a different index entry, the user can select graphical object 506 to view the previous index entry or graphical object 508 to select the next index entry in the dynamic index. For example, the previous index entry or the next index entry can be presented immediately after the currently displayed index entry (e.g., without displaying the index of GUI 300).

In some implementations, GUI 500 can include index list 510. For example, index list 510 can present identifiers (e.g., chapter numbers, page numbers, line numbers, etc.) for index entries in the dynamic index. The user can provide touch input 512 to an identifier in index list 510 to cause a full screen view of the index entry corresponding to the identifier to be displayed in GUI 500. For example, the user can tap an identifier view a single index entry or the user can slide the user's finger 512 along the list of index entry identifiers to view index entries in rapid succession according to how fast the user's finger 512 is moving along the list. The index entries in index list 510 can be presented in a full screen display and in succession immediately after a previously selected or displayed index entry in index list 510 (e.g., without displaying the index of GUI 300).

The terms ‘read mode’ and ‘index mode’ are used herein to distinguish between a normal full screen display (read mode) of media content and a full screen display of an index entry (index mode). For example, GUI 100 displays content in read mode (e.g., the dynamic index has not been invoked). GUI 500 displays content in index mode, for example. In some implementations, index mode can provide different functionality than read mode. For example, in index mode, index status bar 502 and index list 510 can be displayed. In read mode, index status bar 502 and index list 510 are not displayed.

In some implementations, touch input and/or gestures received from a user while in index mode can invoke different operations than touch input and/or gestures received while in read mode. For example, a two finger swipe gesture 514 received in read mode can turn the page of a digital book while a two finger swipe 514 in index mode can cause the previous or next index entry to be displayed on GUI 500. For example, the two finger swipe gesture 514 can cause the previous or next index entry to be immediately displayed in full screen mode (e.g., without having to return to or display the index of GUI 300). For example, content of the media item (e.g., pages, chapters, etc) can be skipped when moving from index entry to index entry in the manner described above.

In some implementations, GUI 500 can include graphical object 516 which when selected causes the currently displayed content to be displayed in read mode, as described above. For example, selection of graphical object 516 causes the application to exit the index mode and resume read mode at the currently displayed location of the media item.

### Returning to the Dynamic Index

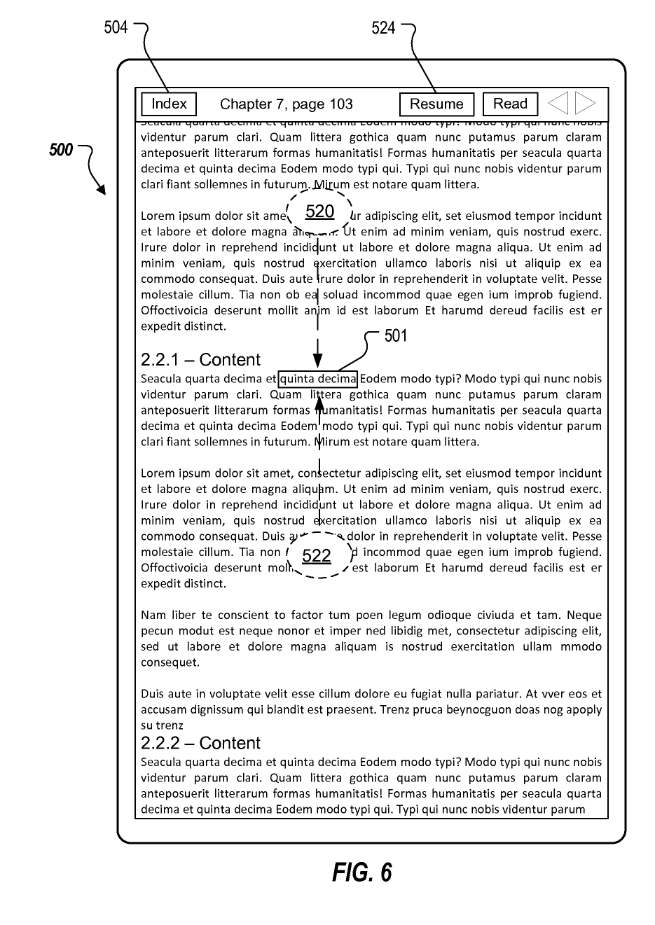

FIG. 6 illustrates example mechanisms for returning to the dynamic index from the full screen display of GUI 500. In some implementations, status bar 502 can include graphical object 504 which when selected causes GUI 300 to be displayed. For example, a user can select graphical object 504 to return to the index display of GUI 300. In some implementations, the user can input a pinch gesture to cause GUI 300 to be displayed. For example, in response to receiving touch input 520 and touch input 522 in the form of a pinch gesture on GUI 500, the index display of GUI 300 can be presented. Thus, the user can navigate between the index display of GUI 300 and the full screen index mode display of GUI 500 by providing touch input gestures (e.g., pinch and de-pinch) to GUI 300 and GUI 500.

In some implementations, status bar 502 can include graphical object 524 which when selected displays content at the location of the media item where the user invoked the dynamic index. For example, if the user is reading a digital book and invokes the dynamic index from a term on page 17 of the book, selecting graphical object 524 will display page 17 of the book in read mode. For example, selecting graphical object 524 will return display GUI 100 of FIG. 1.

### Example Process

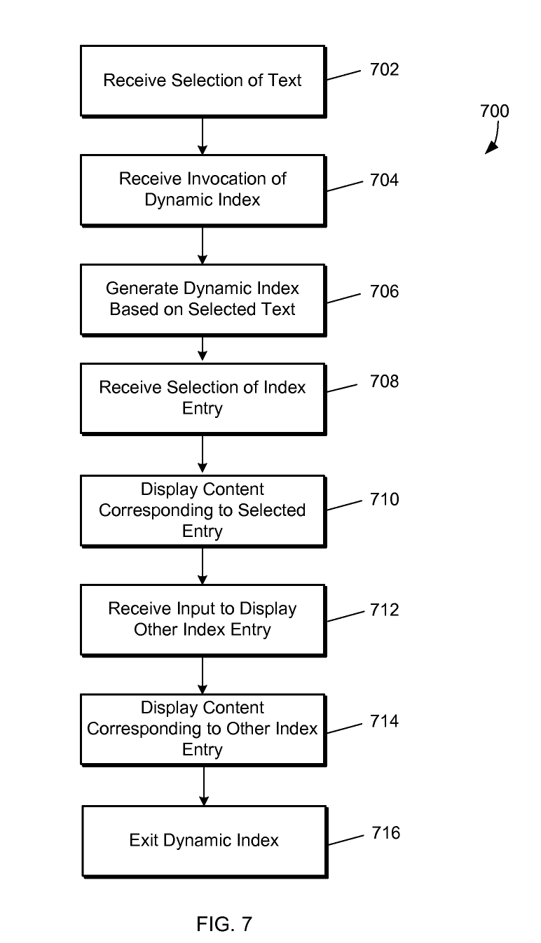

FIG. 7 is flow diagram of an example process 700 for generating and navigating the dynamic index. At step 702, a selection of text can be received. For example, an application executing on a computing device (e.g., a mobile device) can display textual content of a media item on a display of the computing device. The application and/or computing device can receive input (e.g., touch input) selecting a word or phrase (e.g., a term) in the displayed text.

At step 704, an invocation of a dynamic index can be received. For example, once the user has selected (e.g., highlighted) a term in the displayed text, a menu can be displayed that includes a selectable object for invoking the dynamic index. In some implementations, once the user has selected a term in the displayed text, the user can input a touch gesture (e.g., a pinch gesture) to invoke the dynamic index.

At step 706, the dynamic index can be generated based on the selected text. For example, the media item can be searched for other instances of the selected term in the document. If the term is a phrase containing more than one word, the search can be performed by finding instances of the entire phrase, a portion of the phrase, or just keywords of the phrase. In some implementations, the user can input Boolean operators to specify how the words in the phrase should be used to perform the search. Once the search has found an instance of the selected term, the dynamic index can be displayed. For example, the dynamic index can be displayed and populated with index entries as each instance of the term is found or the dynamic index can be populated with index entries after the search through the media item is complete. In some implementations, each entry in the index can identify the location in the media item where the corresponding instance of the selected term was found and each index entry can display some of the text surrounding the instance of the selected term.

At step 708, a selection of an index entry can be received. For example, the user can select an index entry by tapping a displayed index entry. The user can select an index entry by performing a multi-touch gesture (e.g., a de-pinch gesture) with respect to the index entry.

At step 710, content corresponding to the selected index entry can be displayed. For example, in response to receiving a de-pinch gesture corresponding to the selected index entry, additional content near the corresponding instance of the selected term can be displayed. The amount of additional content can correspond to the size and velocity of the de-pinch gesture, for example. In some implementations, the de-pinch gesture can invoke a full screen display of index entry, as described above with reference to FIG. 4 and FIG. 5.

At step 712, input can be received to display another index entry. For example, once a full screen display of an index entry is presented in index mode, the user can provide input to display other index entries in full screen mode without having to navigate back to the dynamic index. For example, a user can select a graphical object to cause a full screen display of another entry (e.g., previous or next entry) in the index to be presented. The user can input a touch gesture (e.g., a swipe gesture) to cause a full screen display of the previous or next entry in the index to be presented, at step 714.

At step 716, the dynamic index can be exited. For example, the user can select a graphical object to exit index mode and enter read mode. In some implementations, if the user exits index mode while viewing a full screen display of an index entry, then the user can continue to read from the location in the media item corresponding to the index entry. For example, the content currently presented on the display of the computing device will remain displayed. In some implementations, when the user exits index mode, the user can be returned to the location in the media item from where the dynamic index was invoked. For example, the location in the media item from where the user invoked the dynamic index can be displayed.

### Alternate Implementations

The description above describes the dynamic index in terms of textual media (e.g., digital books, text documents, etc.) However, the dynamic index can be used to index content in other types of media. In some implementations, the dynamic index described above can be used to index a photo library. For example, a user can select an object (e.g., a face) in a photograph of a digital photo library. The computing device can compare the selected object to objects in other photographs in the digital photo library. For example, the computing device can use facial recognition techniques to compare a selected face to faces in other photographs in the digital photo library. The computing device can use metadata (e.g., user provided descriptions, labels or tags) to compare the selected object to other objects in the digital photo library.

Once other instances of the selected object has been found in other photographs in the digital photo library, a dynamic index can be generated that identifies the photographs that contain the selected object. Each index entry can include an identifier for the corresponding photograph and a preview portion (e.g., clipped to the matching object) of the corresponding photograph. The user can provide input to the dynamic photo index to enlarge the preview portion of the corresponding photograph or to display the entirety of the corresponding photograph (e.g., full screen view). The user can provide input to move between photo index entries without having to return to the dynamic index. For example, the user can input a swipe gesture to a currently displayed photograph to cause the next a photograph corresponding to the previous or next index entry to be displayed.

### Example System Architecture

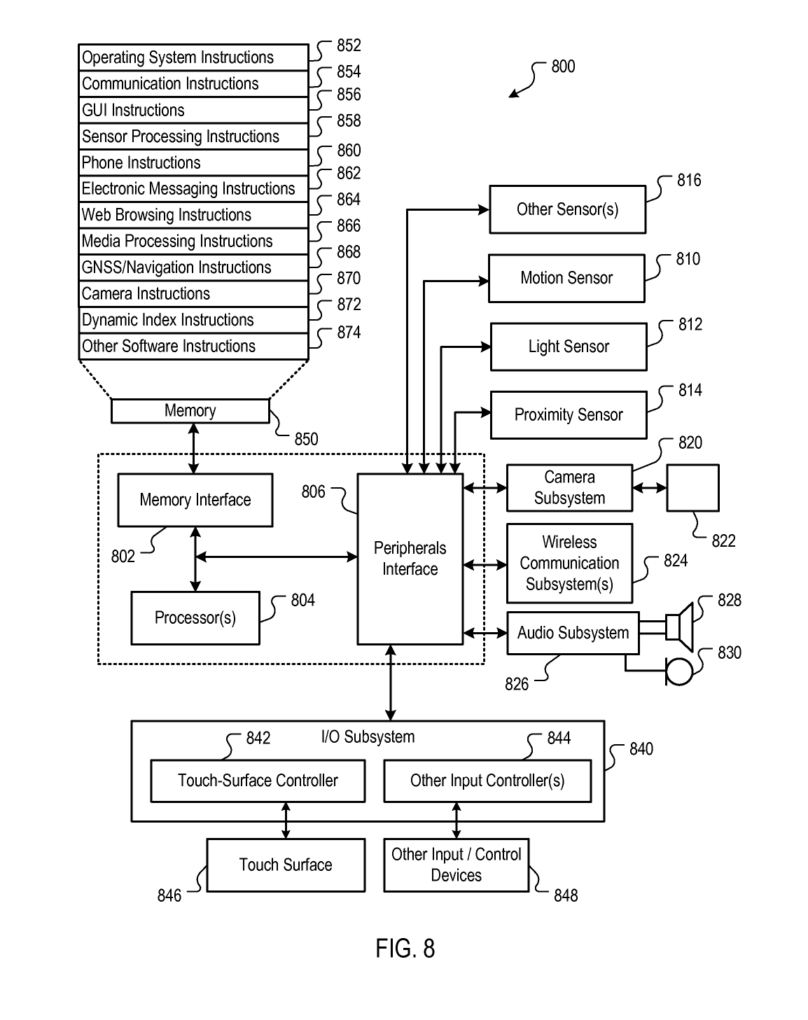

FIG. 8 is a block diagram of an example computing device 800 that can implement the features and processes of FIGS. 1-7. The computing device 800 can include a memory interface 802, one or more data processors, image processors and/or central processing units 804, and a peripherals interface 806. The memory interface 802, the one or more processors 804 and/or the peripherals interface 806 can be separate components or can be integrated in one or more integrated circuits. The various components in the computing device 800 can be coupled by one or more communication buses or signal lines.

Sensors, devices, and subsystems can be coupled to the peripherals interface 806 to facilitate multiple functionalities. For example, a motion sensor 810, a light sensor 812, and a proximity sensor 814 can be coupled to the peripherals interface 806 to facilitate orientation, lighting, and proximity functions. Other sensors 816 can also be connected to the peripherals interface 806, such as a global navigation satellite system (GNSS) (e.g., GPS receiver), a temperature sensor, a biometric sensor, magnetometer or other sensing device, to facilitate related functionalities.

A camera subsystem 820 and an optical sensor 822, e.g., a charged coupled device (CCD) or a complementary metal-oxide semiconductor (CMOS) optical sensor, can be utilized to facilitate camera functions, such as recording photographs and video clips. The camera subsystem 820 and the optical sensor 822 can be used to collect images of a user to be used during authentication of a user, e.g., by performing facial recognition analysis.

Communication functions can be facilitated through one or more wireless communication subsystems 824, which can include radio frequency receivers and transmitters and/or optical (e.g., infrared) receivers and transmitters. The specific design and implementation of the communication subsystem 824 can depend on the communication network(s) over which the computing device 800 is intended to operate. For example, the computing device 800 can include communication subsystems 824 designed to operate over a GSM network, a GPRS network, an EDGE network, a Wi-Fi or WiMax network, and a Bluetooth™ network. In particular, the wireless communication subsystems 824 can include hosting protocols such that the device 100 can be configured as a base station for other wireless devices.

An audio subsystem 826 can be coupled to a speaker 828 and a microphone 830 to facilitate voice-enabled functions, such as speaker recognition, voice replication, digital recording, and telephony functions. The audio subsystem 826 can be configured to facilitate processing voice commands, voiceprinting and voice authentication, for example.

The I/O subsystem 840 can include a touch-surface controller 842 and/or other input controller(s) 844. The touch-surface controller 842 can be coupled to a touch surface 846. The touch surface 846 and touch-surface controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 846.

The other input controller(s) 844 can be coupled to other input/control devices 848, such as one or more buttons, rocker switches, thumb-wheel, infrared port, USB port, and/or a pointer device such as a stylus. The one or more buttons (not shown) can include an up/down button for volume control of the speaker 828 and/or the microphone 830.

In one implementation, a pressing of the button for a first duration can disengage a lock of the touch surface 846; and a pressing of the button for a second duration that is longer than the first duration can turn power to the computing device 800 on or off. Pressing the button for a third duration can activate a voice control, or voice command, module that enables the user to speak commands into the microphone 830 to cause the device to execute the spoken command. The user can customize a functionality of one or more of the buttons. The touch surface 846 can, for example, also be used to implement virtual or soft buttons and/or a keyboard.

In some implementations, the computing device 800 can present recorded audio and/or video files, such as MP3, AAC, and MPEG files. In some implementations, the computing device 800 can include the functionality of an MP3 player, such as an iPod™. The computing device 800 can, therefore, include a 36-pin connector that is compatible with the iPod. Other input/output and control devices can also be used.

The memory interface 802 can be coupled to memory 850. The memory 850 can include high-speed random access memory and/or non-volatile memory, such as one or more magnetic disk storage devices, one or more optical storage devices, and/or flash memory (e.g., NAND, NOR). The memory 850 can store an operating system 852, such as Darwin, RTXC, LINUX, UNIX, OS X, WINDOWS, or an embedded operating system such as VxWorks.

The operating system 852 can include instructions for handling basic system services and for performing hardware dependent tasks. In some implementations, the operating system 852 can be a kernel (e.g., UNIX kernel). In some implementations, the operating system 852 can include instructions for performing voice commands. For example, operating system 852 can implement the dynamic indexing features as described with reference to FIGS. 1-7.

The memory 850 can also store communication instructions 854 to facilitate communicating with one or more additional devices, one or more computers and/or one or more servers. The memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GNSS/Navigation instructions 868 to facilitate GNSS and navigation-related processes and instructions; and/or camera instructions 870 to facilitate camera-related processes and functions.

The memory 850 can store software instructions 872 to facilitate the dynamic indexing processes and functions as described with reference to FIGS. 1-7. The memory 850 can also store other software instructions 874, such as web video instructions to facilitate web video-related processes and functions; and/or web shopping instructions to facilitate web shopping-related processes and functions. In some implementations, the media processing instructions 866 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 850 can include additional instructions or fewer instructions. Furthermore, various functions of the computing device 800 can be implemented in hardware and/or in software, including in one or more signal processing and/or application specific integrated circuits.

What is claimed is:

1. A method comprising:
displaying, on a display of a computing device, a list having entries identifying instances of a user-specified term within text of media item;
receiving user input corresponding to a particular entry in the list, where the user input includes a first touch input and a second touch input;
detecting that a distance between the first touch input and the second touch input has changed from a first length to a second length;
adjusting a size of the particular entry in the list to correspond to the second length.

2. The method of claim 1, wherein the user input is touch input corresponding to a de-pinch gesture.

3. The method of claim 2, further comprising:
expanding the particular entry from a first size to a second size according to a magnitude of the de-pinch gesture.

4. The method of claim 1, wherein the particular entry returns to the first size when the input is no longer received.

5. The method of claim 1, where expanding the particular entry comprises presenting a full screen display of content at a location in the media item corresponding to the particular entry when a velocity of the user input or a size of the particular index entry exceeds a threshold value.

6. A method comprising:
presenting, on a display of a computing device, a full screen view of content at a first location in a media item corresponding to a first entry of a list of instances of a term in the media item;
receiving touch input to a touch sensitive device, the input corresponding to a swipe gesture; and
in response to the touch input, presenting a full screen view of content at a second location in the media item corresponding to a second entry of the list.

7. The method of claim 6, wherein the second entry is immediately before or immediately after the first entry in the list.

8. The method of claim 6, wherein the second location in the media item is presented immediately after the first location in the media item.

9. A non-transitory computer-readable medium including one or more sequences of instructions which, when executed by one or more processors, causes:
displaying, on a display of a computing device, a list having entries identifying instances of a user-specified term within text of media item;
receiving user input corresponding to a particular entry in the list, where the user input includes a first touch input and a second touch input;
detecting that a distance between the first touch input and the second touch input has changed from a first length to a second length;
adjusting a size of the particular entry in the list to correspond to the second length.

10. The non-transitory computer-readable medium of claim 9, wherein the user input is touch input corresponding to a de-pinch gesture.

11. The non-transitory computer-readable medium of claim 10, wherein the instructions cause:
expanding the particular entry from a first size to a second size according to a magnitude of the de-pinch gesture.

12. The non-transitory computer-readable medium of claim 9, wherein the particular entry returns to the first size when the input is no longer received.

13. The non-transitory computer-readable medium of claim 9, where expanding the particular entry comprises presenting a full screen display of content at a location in the media item corresponding to the particular entry when a velocity of the user input or a size of the particular index entry exceeds a threshold value.

14. A non-transitory computer-readable medium including one or more sequences of instructions which, when executed by one or more processors, causes:
presenting, on a display of a computing device, a full screen view of content at a first location in a media item corresponding to a first entry of a list of instances of a term in the media item;
receiving touch input to a touch sensitive device, the input corresponding to a swipe gesture; and
in response to the touch input, presenting a full screen view of content at a second location in the media item corresponding to a second entry of the list.

15. The non-transitory computer-readable medium of claim 14, wherein the second entry is immediately before or immediately after the first entry in the list.

16. The non-transitory computer-readable medium of claim 14, wherein the second location in the media item is presented immediately after the first location in the media item.

17. A system comprising:
one or more processors; and
a non-transitory computer-readable medium including one or more sequences of instructions which, when executed by the one or more processors, causes:
displaying, on a display of a computing device, a list having entries identifying instances of a user-specified term within text of media item;
receiving user input corresponding to a particular entry in the list, where the user input includes a first touch input and a second touch input;
detecting that a distance between the first touch input and the second touch input has changed from a first length to a second length;
adjusting a size of the particular entry in the list to correspond to the second length.

18. The system of claim 17, wherein the user input is touch input corresponding to a de-pinch gesture.

19. The system of claim 18, wherein the instructions cause:
expanding the particular entry from a first size to a second size according to a magnitude of the de-pinch gesture.

20. The system of claim 17, wherein the particular entry returns to the first size when the input is no longer received.

21. The system of claim 17, where expanding the particular entry comprises presenting a full screen display of content at a location in the media item corresponding to the particular entry when a velocity of the user input or a size of the particular index entry exceeds a threshold value.

22. A system comprising:
one or more processors; and
a non-transitory computer-readable medium including one or more sequences of instructions which, when executed by the one or more processors, causes:
presenting, on a display of a computing device, a full screen view of content at a first location in a media item corresponding to a first entry of a list of instances of a term in the media item;
receiving touch input to a touch sensitive device, the input corresponding to a swipe gesture; and
in response to the touch input, presenting a full screen view of content at a second location in the media item corresponding to a second entry of the list.

23. The system of claim 22, wherein the second entry is immediately before or immediately after the first entry in the list.

24. The system of claim 22, wherein the second location in the media item is presented immediately after the first location in the media item.
